(19) United States
(12) Patent Application Publication
(10) Pub. No.: US 2025/0105980 A1
(43) Pub. Date: Mar. 27, 2025

(54) METHOD AND APPARATUS FOR CONFIGURING RESOURCES FOR SBFD OPERATION

(71) Applicant: Nokia Technologies Oy, Espoo (FI)

(72) Inventors: Jie GAO, Hangzhou (CN); Youngsoo YUK, Seoul (KR); Jing Yuan SUN, Beijing (CN); Nhat-Quang NHAN, Massy (FR); Guillermo POCOVI, Aalborg (DK)

(21) Appl. No.: 18/812,415

(22) Filed: Aug. 22, 2024

(30) Foreign Application Priority Data
Sep. 21, 2023 (WO) PCT/CN2023/120404

(51) Int. Cl. H04L 5/00; H04L 5/14

(52) U.S. Cl. CPC H04L 5/0053; H04L 5/0051; H04L 5/0094; H04L 5/14

(57) ABSTRACT

Embodiments of the present disclosure provide a method and an apparatus for configuring resources for subband full duplex, SBFD, operation. A method (400) performed by a terminal device, comprising: receiving (S402), from a network node, a subband full duplex, SBFD, slot configuration; and communicating (S404), with the network node, based at least on the SBFD slot configuration. The slot configuration indicates a plurality of radio resources of a slot; and the plurality of radio resources include: at least one downlink, DL, radio resource used for DL transmission; and at least one flexible radio resource used for flexible scheduling. According to embodiments of the present disclosure, the exemplary embodiments of the present disclosure propose a mechanism to specifically configure/allocate resources for subband full duplex, SBFD, operation.

### TECHNICAL FIELD

Various example embodiments of the present disclosure relate generally to the technology of communication, and in particular to a method and an apparatus for configuring resources for subband full duplex, SBFD, operation.

### BACKGROUND

In current communication system, such as 3GPP 5G NR (3rd generation partnership project, 5th generation, new radio), two duplexing modes may be supported: FDD (frequency division duplexing) for paired bands and TDD (time division duplexing) for unpaired bands.

In such modes, a certain time-frequency resource may be used by a terminal device for either transmitting (such as an uplink, UL) or receiving (such as a downlink, DL). A reference signal related to this certain time-frequency resource may be measured to estimate the communication quality, and the measurement result may be reported by the terminal device to another entity, such as a base station.

For improving the efficiency of utilizing the transmission resources, the duplexing modes may be further improved or developed. For example, simultaneous DL and UL transmission on different physical resource blocks (PRBs) or subbands within an unpaired wideband NR cell may be allowed. Thus, the allocation of the transmission resources will be much more flexible.

However, how to specifically configure/allocate such resources with new duplexing modes for different kinds of transmissions are still in study.

### SUMMARY

This summary is provided to introduce some aspects in a simplified form that are further described below in the detailed description. This summary is not intended to identify key features or essential features of the claimed subject matter, nor is it intended to be used to limit the scope of the claimed subject matter.

Certain aspects of the present disclosure and their embodiments may provide solutions to these or other challenges. There are, proposed herein, various embodiments which address one or more of the issues disclosed herein. Specific method and apparatus for configuring resources for subband full duplex, SBFD, operation may be provided.

A first aspect of the present disclosure provides a method performed by a terminal device. The method comprises: receiving, from a network node, a subband full duplex, SBFD, slot configuration; and communicating, with the network node, based at least on the SBFD slot configuration. The slot configuration indicates a plurality of radio resources of a slot. The plurality of radio resources include: at least one downlink, DL, radio resource used for DL transmission; and at least one flexible radio resource used for flexible scheduling.

In exemplary embodiments of the present disclosure, the plurality of radio resources further include: at least one dedicated uplink, UL, radio resource used for UL transmission. A dedicated UL radio resource in the at least one dedicated UL radio resource is surrounded by the at least one flexible radio resource, in a frequency domain and/or time domain.

In exemplary embodiments of the present disclosure, the at least one dedicated UL radio resource is dedicated from a part of the at least one flexible radio resource, for UL transmission.

In exemplary embodiments of the present disclosure, a frequency domain position of a radio resource in the plurality of radio resources is indicated by a start resource block, RB, and a number of RBs. A time domain position of the radio resource is indicated by a slot, and a start symbol and a number of symbols in the slot.

In exemplary embodiments of the present disclosure, at least one flexible control resource set, CORESET, is configured in the plurality of radio resources. A flexible CORESET of the at least one flexible CORESET is configured across at least one of: a DL radio resource, a flexible radio resource, and a dedicated UL radio resource. The flexible CORESET is configured statically by radio resource control, RRC, or dynamically by downlink control information, DCI, or media access control control element, MAC CE.

In exemplary embodiments of the present disclosure, the method further comprises: monitoring a physical downlink control channel, PDCCH, in the flexible CORESET, when the flexible CORESET is earlier than an associated UL transmission by a predefined time length. The predefined time length is based on at least one of: a decoding time for the PDCCH, a time advance, TA, and a transient time from DL to UL of the terminal device.

In exemplary embodiments of the present disclosure, when a UL transmission overlaps with the flexible CORESET, the UL transmission has a high priority than the PDCCH in the flexible CORESET.

In exemplary embodiments of the present disclosure, the method comprises: judging whether all of the at least one flexible radio resource is dedicated for UL transmission, based on at least one of: the SBFD slot configuration or information from the flexible CORESET.

In exemplary embodiments of the present disclosure, a flexible radio resource is used for guard band or DL transmission, when the flexible radio resource is not dedicated for UL transmission.

In exemplary embodiments of the present disclosure, at least one reference signal from the network node is configured in the plurality of radio resources. A reference signal of the at least one reference signal is configured across at least one of: a DL radio resource, a flexible radio resource, and a dedicated UL radio resource.

In exemplary embodiments of the present disclosure, the method comprises: receiving the reference signal, when the reference signal is earlier than an associated UL transmission by a predefined time length; and transmitting based at least on a measurement result of the reference signal. The predefined time length is based on at least one of: a guard period, a time advance, TA, and a transient time from DL to UL of the terminal device.

In exemplary embodiments of the present disclosure, the reference signal comprises at least one of: a tracking reference signal, TRS, or a flexible channel state information reference signal, CSI-RS.

In exemplary embodiments of the present disclosure, the terminal device comprises a user equipment, UE. The network node comprises a base station.

A second aspect of the present disclosure provides a method performed by a network node. The method comprises: transmitting, to a terminal device, a subband full duplex, SBFD, slot configuration; and communicating, with the terminal device, based at least on the SBFD slot configuration. The slot configuration indicates a plurality of radio resources of a slot. The plurality of radio resources include: at least one downlink, DL, radio resource used for DL transmission; and at least one flexible radio resource used for flexible scheduling.

In exemplary embodiments of the present disclosure, the plurality of radio resources further include: at least one dedicated uplink, UL, radio resource used for UL transmission. A dedicated UL radio resource in the at least one dedicated UL radio resource is surrounded by the at least one flexible radio resource, in a frequency domain and/or time domain.

In exemplary embodiments of the present disclosure, the at least one dedicated UL radio resource is dedicated from a part of the at least one flexible radio resource, for UL transmission.

In exemplary embodiments of the present disclosure, a frequency domain position of a radio resource in the plurality of radio resources is indicated by a start resource block, RB, and a number of RBs. A time domain position of the radio resource is indicated by a slot, and a start symbol and a number of symbols in the slot.

In exemplary embodiments of the present disclosure, at least one flexible control resource set, CORESET, is configured in the plurality of radio resources. A flexible CORESET of the at least one flexible CORESET is configured across at least one of: a DL radio resource, a flexible radio resource, and a dedicated UL radio resource. The flexible CORESET is configured statically by radio resource control, RRC, or dynamically by downlink control information, DCI, or media access control control element, MAC CE.

In exemplary embodiments of the present disclosure, when the network node allocates radio resources for PDCCH in the flexible CORESET, the network node skips UL radio resources. When a UL transmission overlaps with the flexible CORESET, the UL transmission has a high priority than the PDCCH in the flexible CORESET.

In exemplary embodiments of the present disclosure, a flexible radio resource is used for guard band or DL transmission, when the flexible radio resource is not dedicated for UL transmission.

In exemplary embodiments of the present disclosure, at least one reference signal from the network node is configured in the plurality of radio resources. A reference signal of the at least one reference signal is configured across at least one of: a DL radio resource, a flexible radio resource, and a dedicated UL radio resource.

In exemplary embodiments of the present disclosure, the method further comprises: transmitting the reference signal earlier than an associated UL transmission by a predefined time length; and receiving, from the terminal device, a transmission based at least on a measurement result of the reference signal. The predefined time length is based on at least one of: a guard period, a time advance, TA, and a transient time from DL to UL of the terminal device.

In exemplary embodiments of the present disclosure, the reference signal comprises at least one of: a tracking reference signal, TRS, or a flexible channel state information reference signal, CSI-RS.

In exemplary embodiments of the present disclosure, the terminal device comprises a user equipment, UE. The network node comprises a base station.

A third aspect of the present disclosure provides a terminal device comprising means configured for: receiving, from a network node, a subband full duplex, SBFD, slot configuration; and communicating, with the network node, based at least on the SBFD slot configuration. The slot configuration indicates a plurality of radio resources of a slot. The plurality of radio resources include: at least one downlink, DL, radio resource used for DL transmission; and at least one flexible radio resource used for flexible scheduling.

In exemplary embodiments of the present disclosure, the means are further configured for performing the method according any of the embodiments in the first aspect.

In exemplary embodiments of the present disclosure, the means comprise: at least one processor; and at least one memory storing instructions that, when executed by the at least one processor, cause the performance of the terminal device.

A fourth aspect of the present disclosure provides a network node comprising means configured for: transmitting, to a terminal device, a subband full duplex, SBFD, slot configuration; and communicating, with the terminal device, based at least on the SBFD slot configuration. The slot configuration indicates a plurality of radio resources of a slot. The plurality of radio resources include: at least one downlink, DL, radio resource used for DL transmission; and at least one flexible radio resource used for flexible scheduling.

In exemplary embodiments of the present disclosure, the means are further configured for performing the method according any of the embodiments in the second aspect.

In exemplary embodiments of the present disclosure, the means comprise: at least one processor; and at least one memory storing instructions that, when executed by the at least one processor, cause the performance of the network node.

A fifth aspect of the present disclosure provides a computer-readable storage medium storing instructions, which when executed by at least one processor of a terminal device, cause the at least one processor of the terminal device to perform the method according to any of the embodiments of the first aspect; or when executed by at least one processor of a network node, cause the at least one processor of the network node to perform the method according to any of the embodiments of the second aspect.

A sixth aspect of the present disclosure provides an apparatus. The apparatus comprises: at least one processor; and at least one memory storing instructions that, when executed by the at least one processor, cause the apparatus at least to perform the method according to any of embodiments of the first aspect.

In exemplary embodiments of the present disclosure, the apparatus is or is comprised in the terminal device.

A seventh aspect of the present disclosure provides an apparatus. The apparatus comprises: at least one processor; and at least one memory storing instructions that, when executed by the at least one processor, cause the apparatus at least to perform the method according to any of embodiments of the second aspect.

In exemplary embodiments of the present disclosure, the apparatus is or is comprised in the network node.

Embodiments herein afford many advantages. According to embodiments of the present disclosure, an improved manner for configuring resources for subband full duplex, SBFD, operation may be provided.

According to embodiments of the present disclosure, the exemplary embodiments of the present disclosure propose a mechanism to specifically configure/allocate resources for subband full duplex, SBFD, operation.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram showing frequency-time resource partitioning with SBFD as compared to traditional FDD and TDD.

FIG. 2 is a diagram illustrating SBFD and non-SBFD slots.

FIG. 3 is a diagram showing an exemplary frequency location of the UL/DL subband and guardband.

FIG. 4A is a flow chart showing a method performed by a terminal device, according to exemplary embodiments of the present disclosure.

FIG. 4B is a flow chart showing further steps of the method as shown in FIG. 4A, according to exemplary embodiments of the present disclosure.

FIG. 4C is a flow chart showing further steps of the method as shown in FIG. 4A, according to exemplary embodiments of the present disclosure.

FIG. 4D is a flow chart showing further steps of the method as shown in FIG. 4A, according to exemplary embodiments of the present disclosure.

FIG. 5A is a flow chart showing a method performed by a network node, according to exemplary embodiments of the present disclosure.

FIG. 5B is a flow chart showing further steps of the method as shown in FIG. 5A, according to exemplary embodiments of the present disclosure.

FIG. 6 is an exemplary flowchart for using flexible channels and subband, according to embodiments of the present disclosure.

FIG. 7A is a diagram showing a SBFD structure configuration, with DL resources and flexible resources.

FIG. 7B is a diagram showing that some flexible resources are dedicated to UL transmissions.

FIG. 8 is a diagram showing Flexible Coreset in SBFD slots.

FIG. 9 is a diagram showing Flexible TRS or CSI-RS in SBFD slots.

FIG. 10 is a block diagram showing an exemplary structure for the terminal device, according to exemplary embodiments of the present disclosure.

FIG. 11 is a block diagram showing an exemplary structure for the network node, according to exemplary embodiments of the present disclosure.

FIG. 12 is a block diagram showing an apparatus/computer readable storage medium, according to embodiments of the present disclosure.

FIG. 13 is a block diagram showing exemplary apparatus units for the terminal device, which is suitable for performing the method according to embodiments of the disclosure.

FIG. 14 is a block diagram showing exemplary apparatus units for the network node, which is suitable for performing the method according to embodiments of the disclosure.

### DETAILED DESCRIPTION

The embodiments of the present disclosure are described in detail with reference to the accompanying drawings. It should be understood that these embodiments are discussed only for better understanding, rather than limitations on the scope of the present disclosure. The described features, advantages, and characteristics of the disclosure may be combined in any suitable manner in one or more embodiments.

Generally, all terms used herein are to be interpreted according to their ordinary meaning in the relevant technical field, unless a different meaning is clearly given and/or is implied from the context in which it is used. The steps of any methods disclosed herein do not have to be performed in the exact order disclosed, unless clearly given and/or implied from the context. Any feature of any of the embodiments disclosed herein may be applied to any other embodiment, wherever appropriate.

As used herein, the term “network” or “communication network” refers to a network following any suitable communication standards (such for an internet network, or any wireless network). For example, wireless communication standards may comprise WLAN (Wireless Local Area Network), new radio (NR), long term evolution (LTE), LTE-Advanced, 5G NR, etc. In the following description, the terms “network” and “system” can be used interchangeably.

The term “network node” refers to a network device or network entity or network function or any other devices (physical or virtual) in a communication network. For example, the network node in the network may include a base station (BS), an access point (AP), or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

The term “terminal device” refers to any end device that can access a communication network and receive services therefrom. By way of example and not limitation, the terminal device refers to a mobile terminal, user equipment (UE), a non-AP device (such as a non-AP STA), or other suitable devices. The terminal device may include, but not limited to, a mobile phone, a cellular phone, a smart phone, a wearable device, a vehicle-mounted wireless terminal device, a vehicle, and the like.

As one example, a terminal device may represent a device configured for communication in accordance with one or more communication standards promulgated by any standard organization, such as 3rd generation partnership project, 3GPP.

As yet another example, in an Internet of Things (IoT) scenario, a terminal device may represent a machine or other device that performs monitoring and/or measurements, and transmits the results of such monitoring and/or measurements to another terminal device and/or network equipment. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Exemplary embodiments of the disclosure are relevant to a method and an apparatus for configuring resources for subband full duplex, SBFD, operation.

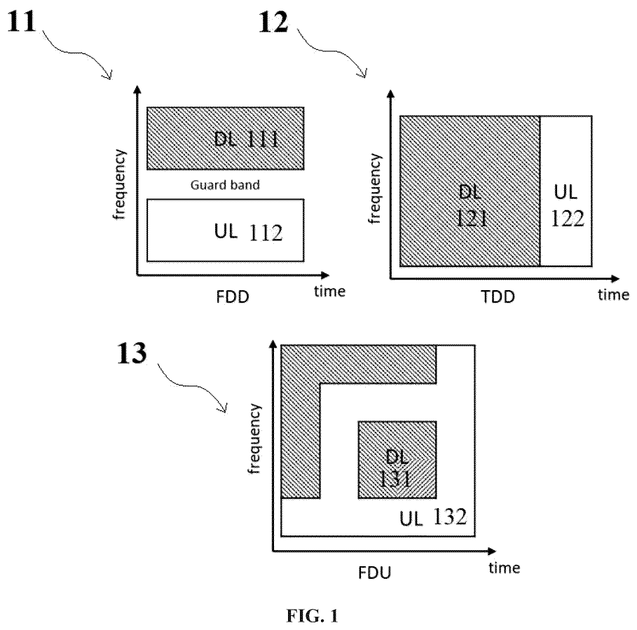

FIG. 1 is a diagram showing frequency-time resource partitioning with SBFD as compared to traditional FDD and TDD.

3GPP 5G NR (3rd generation partnership project, 5th generation, new radio) currently supports two duplexing modes: FDD (frequency division duplexing) 11 for paired bands and TDD (time division duplexing) 12 for unpaired bands. In FDD 11, the frequency domain resource is split between downlink 111, and uplink 112. In TDD 12, the time domain resource is split between downlink 121 and uplink 122. Allocation of a limited time duration for the uplink 122 in TDD 12 would result in reduced coverage, increased latency, and reduced capacity.

Motivated by the above, 3GPP has agreed to initiate a Rel-18 study item (RP-213591, New SI: Study on evolution of NR duplex operation, 3GPP TSG RAN #94-e, Electronic Meeting, Dec. 6-17, 2021) on the evolution of duplexing operation in NR that addresses the challenges above. One of the objectives of the study item is to allow simultaneous DL (downlink) 131 and UL (uplink) 132 transmission on different physical resource blocks (PRBs)/subbands within an unpaired wideband NR cell, as illustrated in FIG. 1. In this disclosure, this is referred to as subband non-overlapping full duplex (SBFD). In other sources, this duplexing scheme is also referred to as cross division duplexing (xDD) scheme or flexible division duplexing (FDU).

Some of objectives of the study item (RP-213591) in the study item description with regards to the present disclosure are listed below.

In this study, the followings are assumed:
Duplex enhancement at the gNB side
Half duplex operation at the UE side
No restriction on frequency ranges
   The detailed objectives are as follows:
( . . . )
Study the subband non-overlapping full duplex and potential enhancements on dynamic/flexible TDD (RAN1, RAN4).
   Identify possible schemes and evaluate their feasibility and performances (RAN1).
   Study inter-gNB and inter-UE CLI handling and identify solutions to manage them (RAN1).
      Consider intra-subband CLI and inter-subband CLI in case of the subband non-overlapping full duplex.
   Study the performance of the identified schemes as well as the impact on legacy operation assuming their co-existence in co-channel and adjacent channels (RAN1).
   1 Study the feasibility of and impact on RF requirements considering adjacent-channel co-existence with the legacy operation (RAN4).
   Study the feasibility of and impact on RF requirements considering the self-interference, the inter-subband CLI, and the inter-operator CLI at gNB and the inter-subband CLI and inter-operator CLI at UE (RAN4).
   ( . . . )

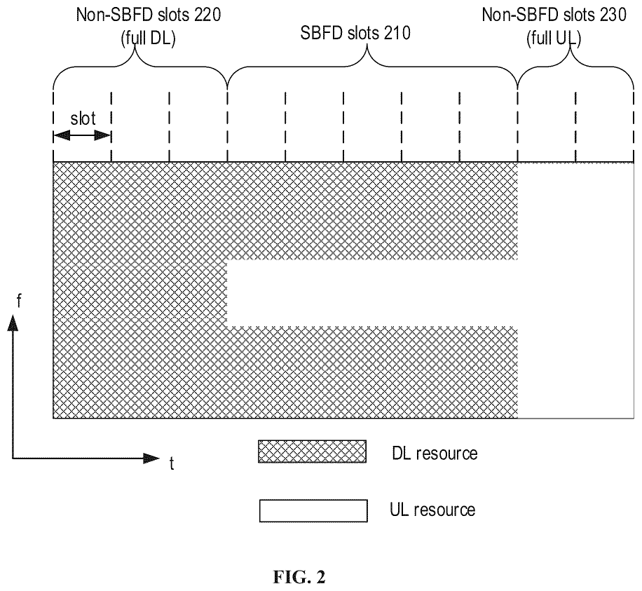

FIG. 2 is a diagram illustrating SBFD and non-SBFD slots.

From the above description of SBFD operation, it can be observed that there are two slot types for both DL and UL transmissions as shown in FIG. 2, namely SBFD slots and non-SBFD slots. SBFD slots 210 are those slots during which the non-overlapping DL subbands and UL subband(s) both exist.

Non-SBFD slots, 220, 230 are those slots during which the entire band is used for either DL (as indicated by 220) or UL (as indicated by 230) (i.e., legacy/full DL/UL slots).

Several SBFD operation modes have been studied including whether time and frequency locations of subbands for SBFD operation are known to the SBFD-aware UE or not. It however has been agreed in 3GPP RAN1 #110 meeting that at least the operation mode with time and frequency locations of subbands for SBFD operation being known to the SBFD-aware UE is prioritized. This means that SBFD slots should be known by the (SBFD-aware) UE in one way or another.

As shown in FIG. 2, For semi-static SBFD, if the frequency domain structure of SBFD is fixed, and the time domain position of SBFD slots are semi-static, then the configuration of many public resources will cause greater problems, such as System synchronization block (SSB), Control resource set 0 (CORESET0), System Information Block (SIB), Random access response (RAR), Message 4 (MSG4), PAGING, Tracking Reference Signal (TRS), and so on. Because these common downlink signals and channels may conflict with the UL subband. If these high-priority signals are to be avoided on the SBFD slots in the time domain, then the configuration of such subbands is very complicated.

Embodiments of the present disclosure will introduce an applicable way to configure subbands and resolve conflicts.

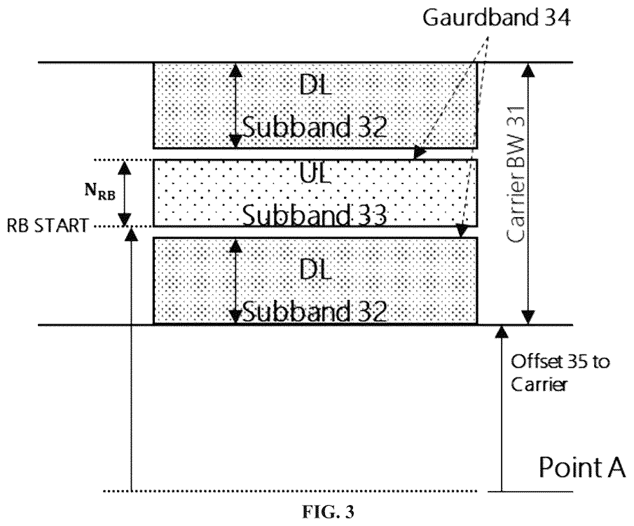

FIG. 3 is a diagram showing an exemplary frequency location of the UL/DL subband and guardband.

Refer to 3GPP document R1-2212115 (Feasibility and techniques for Subband non-overlapping full duplex, 3GPP TSG RAN WG1, Meeting #111, Toulouse, France, Nov. 14-18, 2022), etc., as shown in FIG. 3, a carrier bandwidth (BW) 31 may include DL subbands 32, UL subband 33, and gaurdband 34 therebetween. For example, the frequency location of the uplink-subband (UL-SB) 33 could be indicated in a similar way as the location and bandwidth of bandwidth part (BWP) is configured, by using a Resource indicator value (RIV) indicator for the start RB (RB start) and number of RBs (NRB) of the UL subband 33. The offset 35 to carrier could be with respect to Point A (common resource block 0, CRB0) to indicate the first common resource block (RB) in the UL subband and assuming same sub carrier space (SCS) of the component carrier.

3GPP TS 38.331 V17.5.0 (2023-06) provides CORESET configuration. As per 38.331, the configuration of the CORESET is provided by frequencyDomainResources and a rb-Offset. The frequencyDomainResources is a 45 bits field, where the bits of the bitmap have a one-to-one mapping with non-overlapping groups of 6 consecutive PRBs, in ascending order of the PRB index in the DL BWP bandwidth of PRBs with starting common RB position where the first common RB of the first group of 6 PRBs has common RB index, if the offset is not configured. If the bit value is set to 1 it indicates that the RB group belongs in frequency domain resources of the CORESET. Bits corresponding to a group of RB's not fully contained in the BWP within which the CORESET is configured are set to zero. The rb-Offset indicates the RB level offset in units of RB from the first RB of the first 6RB group to the first RB of BWP.

Based on the 3GPP TS 38.213 V17.6.0 (2023-06) and 38.331 the UE expects a CORESET, for each symbol in which it is defined, to be a multiple of RB Groups, where each RB group consists of 6 RBs.

It is also important to configure CORESET, reference signal, etc. for SBFD operation.

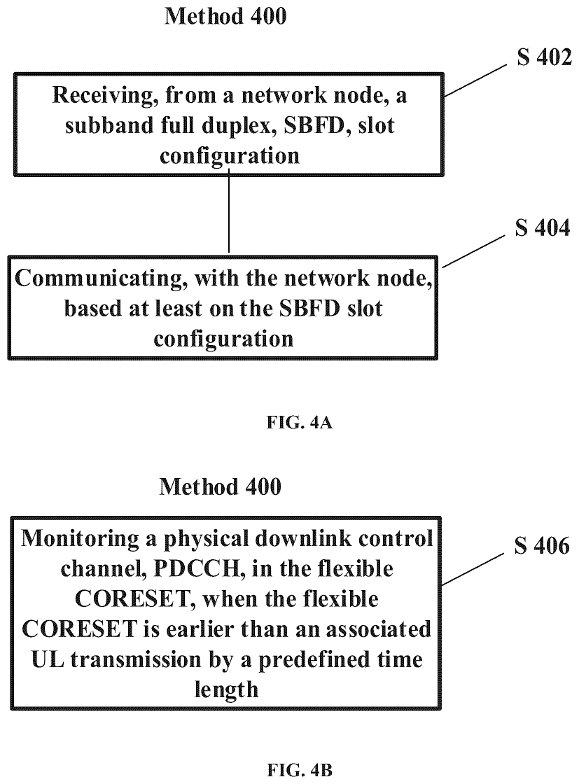

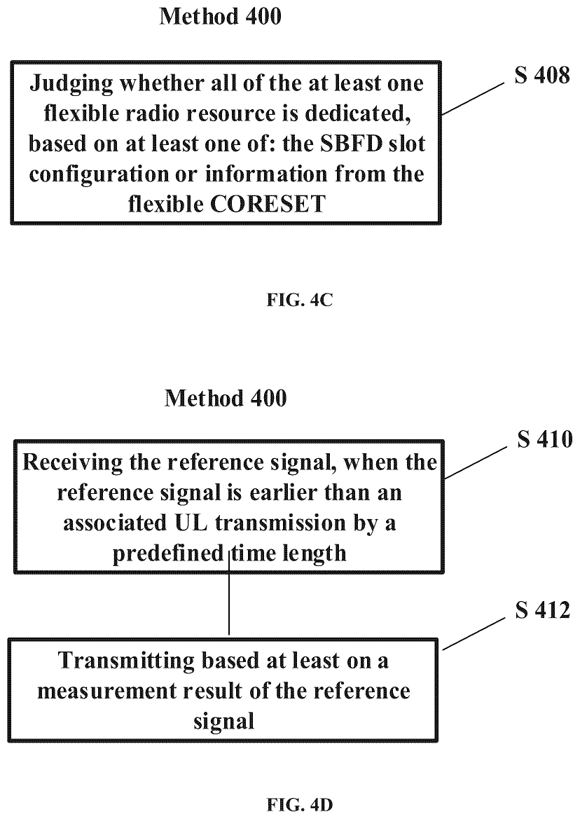

FIG. 4A is a flow chart showing a method performed by a terminal device, according to exemplary embodiments of the present disclosure.

As shown in FIG. 4A, a first aspect of the present disclosure provides a method 400 performed by a terminal device. The method 400 comprises: a step S402, receiving, from a network node, a subband full duplex, SBFD, slot configuration; and a step S404, communicating, with the network node, based at least on the SBFD slot configuration. The slot configuration indicates a plurality of radio resources of a slot. The plurality of radio resources include: at least one downlink, DL, radio resource used for DL transmission; and at least one flexible radio resource used for flexible scheduling.

The step of communicating may include further transmitting and/or receiving.

According to embodiments of the present disclosure, the radio resources for DL transmission and the radio resources for flexible scheduling can be clearly indicated to the terminal device.

In exemplary embodiments of the present disclosure, the plurality of radio resources further include: at least one dedicated uplink, UL, radio resource used for UL transmission. A dedicated UL radio resource in the at least one dedicated UL radio resource is surrounded by the at least one flexible radio resource, in a frequency domain and/or time domain.

In exemplary embodiments of the present disclosure, the at least one dedicated UL radio resource is dedicated from a part of the at least one flexible radio resource, for UL transmission.

According to embodiments of the present disclosure, the radio resources for UL transmission (particularly those dedicated from the flexible radio resources) can be clearly indicated to the terminal device.

In exemplary embodiments of the present disclosure, a frequency domain position of a radio resource in the plurality of radio resources is indicated by a start resource block, RB, and a number of RBs. A time domain position of the radio resource is indicated by a slot, and a start symbol and a number of symbols in the slot.

In exemplary embodiments of the present disclosure, at least one flexible control resource set, CORESET, is configured in the plurality of radio resources. A flexible CORESET of the at least one flexible CORESET is configured across at least one of: a DL radio resource, a flexible radio resource, and a dedicated UL radio resource. The flexible CORESET is configured statically by radio resource control, RRC, or dynamically by downlink control information, DCI, or media access control control element, MAC CE.

According to embodiments of the present disclosure, the flexible CORESET may be used.

FIG. 4B is a flow chart showing further steps of the method as shown in FIG. 4A, according to exemplary embodiments of the present disclosure.

As shown in FIG. 4B, in exemplary embodiments of the present disclosure, the method 400 further comprises: a step S406, monitoring a physical downlink control channel, PDCCH, in the flexible CORESET, when the flexible CORESET is earlier than an associated UL transmission by a predefined time length. The predefined time length is based on at least one of: a decoding time for the PDCCH, a time advance, TA, and a transient time from DL to UL of the terminal device.

According to embodiments of the present disclosure, some timeline may be defined. The predefined time length can ensure the PDCCH and the associated UL transmission may be matched well.

In exemplary embodiments of the present disclosure, when a UL transmission overlaps with the flexible CORESET, the UL transmission has a high priority than the PDCCH in the flexible CORESET.

According to embodiments of the present disclosure, some priority levels may be defined to avoid conflict while still support flexibility.

FIG. 4C is a flow chart showing further steps of the method as shown in FIG. 4A, according to exemplary embodiments of the present disclosure.

As shown in FIG. 4C, in exemplary embodiments of the present disclosure, the method 400 comprises: a step S408, judging whether all of the at least one flexible radio resource is dedicated for UL transmission, based on at least one of: the SBFD slot configuration or information from the flexible CORESET.

In exemplary embodiments of the present disclosure, a flexible radio resource is used for guard band or DL transmission, when the flexible radio resource is not dedicated for UL transmission.

According to embodiments of the present disclosure, the utilization rate of the resource may be improved.

In exemplary embodiments of the present disclosure, at least one reference signal from the network node is configured in the plurality of radio resources. A reference signal of the at least one reference signal is configured across at least one of: a DL radio resource, a flexible radio resource, and a dedicated UL radio resource.

According to embodiments of the present disclosure, the reference signal may be still used.

FIG. 4D is a flow chart showing further steps of the method as shown in FIG. 4A, according to exemplary embodiments of the present disclosure.

As shown in FIG. 4D, in exemplary embodiments of the present disclosure, the method 400 comprises: a step S410, receiving the reference signal, when the reference signal is earlier than an associated UL transmission by a predefined time length; and a step S412, transmitting based at least on a measurement result of the reference signal. The predefined time length is based on at least one of: a guard period, a time advance, TA, and a transient time from DL to UL of the terminal device.

In exemplary embodiments of the present disclosure, the reference signal comprises at least one of: a tracking reference signal, TRS, or a flexible channel state information reference signal, CSI-RS.

According to embodiments of the present disclosure, some timeline may be defined. The predefined time length can ensure the reference signal and the associated UL transmission may be matched well.

In exemplary embodiments of the present disclosure, the terminal device comprises a user equipment, UE. The network node comprises a base station.

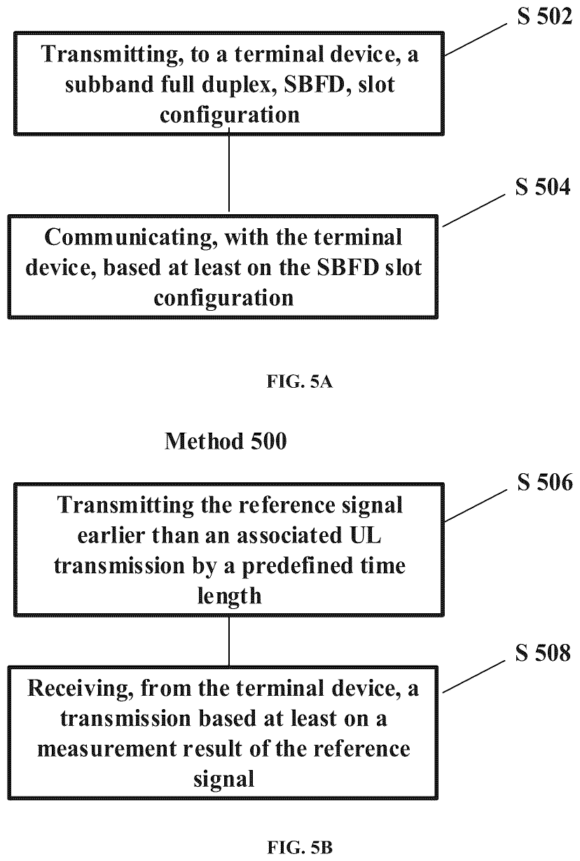

FIG. 5A is a flow chart showing a method performed by a network node, according to exemplary embodiments of the present disclosure.

As shown in FIG. 5A, a second aspect of the present disclosure provides a method performed by a network node. The method 500 comprises: a step S502, transmitting, to a terminal device, a subband full duplex, SBFD, slot configuration; and a step S504, communicating, with the terminal device, based at least on the SBFD slot configuration. The slot configuration indicates a plurality of radio resources of a slot. The plurality of radio resources include: at least one downlink, DL, radio resource used for DL transmission; and at least one flexible radio resource used for flexible scheduling.

In exemplary embodiments of the present disclosure, the plurality of radio resources further include: at least one dedicated uplink, UL, radio resource used for UL transmission. A dedicated UL radio resource in the at least one dedicated UL radio resource is surrounded by the at least one flexible radio resource, in a frequency domain and/or time domain.

In exemplary embodiments of the present disclosure, the at least one dedicated UL radio resource is dedicated from a part of the at least one flexible radio resource, for UL transmission.

In exemplary embodiments of the present disclosure, a frequency domain position of a radio resource in the plurality of radio resources is indicated by a start resource block, RB, and a number of RBs. A time domain position of the radio resource is indicated by a slot, and a start symbol and a number of symbols in the slot.

In exemplary embodiments of the present disclosure, at least one flexible control resource set, CORESET, is configured in the plurality of radio resources. A flexible CORESET of the at least one flexible CORESET is configured across at least one of: a DL radio resource, a flexible radio resource, and a dedicated UL radio resource. The flexible CORESET is configured statically by radio resource control, RRC, or dynamically by downlink control information, DCI, or media access control control element, MAC CE.

In exemplary embodiments of the present disclosure, when the network node allocates radio resources for PDCCH in the flexible CORESET, the network node skips UL radio resources. When a UL transmission overlaps with the flexible CORESET, the UL transmission has a high priority than the PDCCH in the flexible CORESET.

In exemplary embodiments of the present disclosure, a flexible radio resource is used for guard band or DL transmission, when the flexible radio resource is not dedicated for UL transmission.

In exemplary embodiments of the present disclosure, at least one reference signal from the network node is configured in the plurality of radio resources. A reference signal of the at least one reference signal is configured across at least one of: a DL radio resource, a flexible radio resource, and a dedicated UL radio resource.

FIG. 5B is a flow chart showing further steps of the method as shown in FIG. 5A, according to exemplary embodiments of the present disclosure.

As shown in FIG. 5B, in exemplary embodiments of the present disclosure, the method 500 further comprises: a step S506, transmitting the reference signal earlier than an associated UL transmission by a predefined time length; and a step S508, receiving, from the terminal device, a transmission based at least on a measurement result of the reference signal. The predefined time length is based on at least one of: a guard period, a time advance, TA, and a transient time from DL to UL of the terminal device.

In exemplary embodiments of the present disclosure, the reference signal comprises at least one of: a tracking reference signal, TRS, or a flexible channel state information reference signal, CSI-RS.

In exemplary embodiments of the present disclosure, the terminal device comprises a user equipment, UE. The network node comprises a base station.

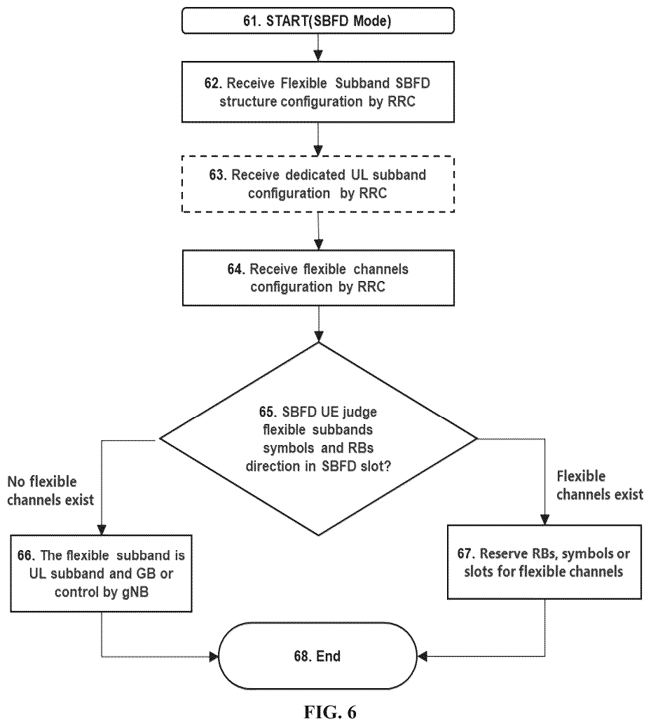

FIG. 6 is an exemplary flowchart for using flexible channels and subband, according to embodiments of the present disclosure.

As shown in FIG. 6, in a step 61, the terminal device (such as a SBFD UE) starts in a SBFD mode.

In a step 62, the UE receives Flexible Subband SBFD structure configuration by RRC.

In a step 63, the UE receives dedicated UL subband configuration by RRC.

In a step 64, the UE receives flexible channels configuration by RRC.

In a step 65, the SBFD UE judges flexible subbands symbols and RBs direction in SBFD slot.

If there is no flexible channel, the UE goes to a step 66, the flexible subband is UL subband and GB or control by gNB.

If there is flexible channel, the UE goes to a step 67, the UE reserve RBs, symbols or slots for flexible channels.

In a step 68, this procedure ends.

Embodiments of the present disclosure introduce flexible channels and flexible subbands using in SBFD network, which can more easily avoid the conflict problem of uplink and downlink, and at the same time can adjust the network more flexibly to improve the utilization rate of network resources, as shown in FIG. 6.

Embodiments of the present disclosure may provide advantages, including at least one of:
A new flexible subband configuration around of UL subband.
A new flexible CORESET which can be used in DL, UL, Flexible subbands.
A new flexible channel state information reference signals (CSI-RS) which can be used in DL, UL, Flexible subbands.
A simple way to indicate SBFD UE that should consider the flexible resources, if the flexible resources are not used, the flexible part is used as guard bands.
A new setup that, if there is no overwriting UL scheduling on the flexible sub-bands reserved for DL, then UE assumes the resource is used for DL (these could be semi-static DL transmissions).
Some timelines which can be defined here as well, e.g., UE does not expect the DCI scheduling an UL transmission that overwrites the (semi-static) DL transmission in the flexible subband arrives later than a threshold.
Benefit to increase the utilization rate of symbols of SBFD UL slots.
Benefit to increase the resources of CORESET and PDCCH.

Further detailed exemplary embodiments will be illustrated below.

One Embodiment is for flexible channel in SBFD.

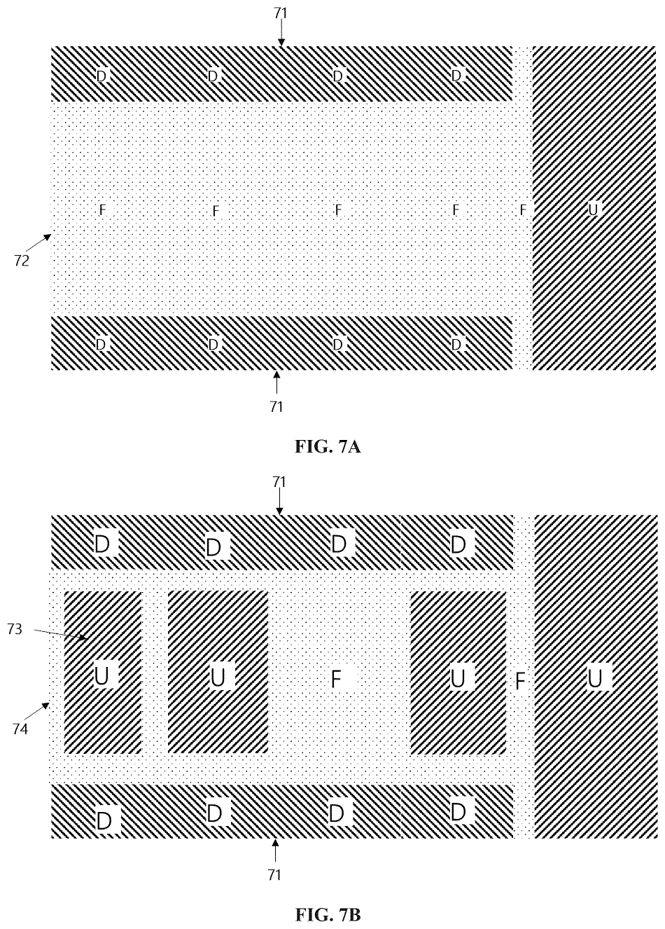

FIG. 7A is a diagram showing a SBFD structure configuration, with DL resources and flexible resources.

FIG. 7B is a diagram showing that some flexible resources are dedicated to UL transmissions.

In this embodiment, NW indicates, and UE receives a SBFD structure configuration.

In this SBFD structure configuration, a number of slots/symbols wherein the frequency band is split into multiple subbands and wherein at least one subband is used for DL transmissions (subband D 71) and at least one subband is used for Flexible transmissions (subband F 72), refer to FIG. 7A, then Flexible transmissions subband (subband F 72) can be further split to dedicated UL subband (subband U 73), refer to FIG. 7B. Thus, the final flexible subbands (F 74) will be around the dedicated UL subband.

For example,
RIV start RB and numofRB (number of RBs) are set for F (flexible) subbands (F 72) in frequency domain, and bitmap is used to indicate the time domain, or all DL slots/symbols are used by RRC.
RIV start RB and numofRB or bitmap are set to indicate the dedicated UL subbands (U 73) in frequency domain, and Start and length indicator value (SLIV) start symbols and numofsymbols are set for dedicated UL subbands (U 73) in time domain, then bitmap can be used to indicate the slots by RRC. UL has higher priority in UL dedicated subbands (U 73).
Then, SBFD aware UE can know the actual flexible subbands (F 74) will be around the dedicated UL subband (U 73). DL has higher priority in F subbands.

The dedicated UL subband can be used for common or dedicated UL part, e.g., Physical uplink control channel (PUCCH), Physical random-access channel (PRACH), Sounding reference signal (SRS), Message 3 (MSG3), etc.

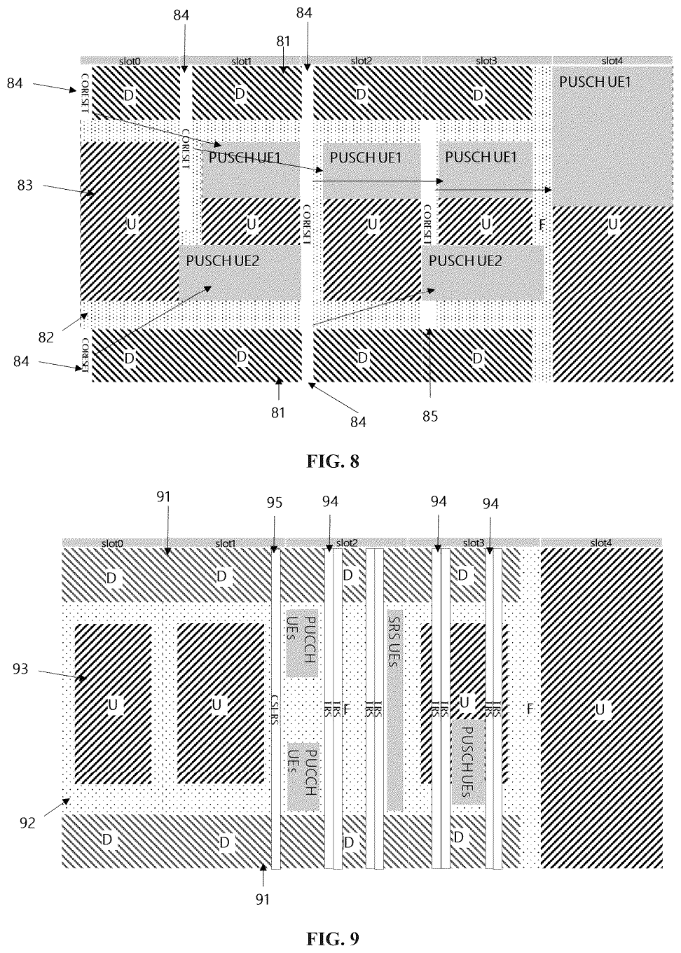

FIG. 8 is a diagram showing Flexible Coreset in SBFD slots.

In another embodiment, NW indicates, and UE receives, Flexible Coreset in SBFD slots, refer to FIG. 8.

In this SBFD structure configuration, a number of slots/symbols wherein the frequency band is split into multiple subbands and wherein at least one subband is used for DL transmissions (subband D 81) and at least one subband is used for Flexible transmissions (subband F 82), then Flexible transmissions subband can further split to dedicate UL subband (subband U 83). Thus, the final flexible subbands will be around the UL subband. Further, flexible CORESETs 84, 85 are configured inside/outside/partly overlapping with the SBFD UL subband or flexible subband. As one example, the CORESETs 84 do not overlap with UL resources, while the CORESET 85 overlaps with UL resources in flexible subband.

UE is required to monitor Physical downlink control channel (PDCCH) in the flexible CORESET 84 only when flexible CORESET 84 is capable to be received by the UE, e.g., CORESET 84 is configured in symbols not overlapping with UL allocation or N_symbols earlier than UL scheduling (such as the PUSCH). Note: N_symbols are including PDCCH decoding time, 2TA (time advance), DL-to-UL transient time (e.g., in the spec or by UE capability).

When NW allocates PDCCH resources on flexible coreset, it skips uplink resources and reserves enough GuardBand for UL resources. Refer to FIG. 8, in slot3, UE2's PUSCH resources are overlapped with CORESET 85, then NW will skip those overlapped resources and Guardband. UL resources will have higher priority than PDCCH in flexible CORESET 85. However, UE1 will still search for PDCCH throughout CORESET 85, and NW can set UE1's PDCCH resources in locations that do not overlap with UE2 UL resources.

The coreset could be statically configured by RRC, or further dynamically indicated via CORESET switch by DCI or media access control control element (MAC CE).

For example, refer to FIG. 8, UE1 has reserved space in the first few symbols of each slot, so UE1 can search for flexible coreset PDCCH in these reserved spaces, and according to the FIG. 8, UE1 can search for PDCCH in DL subbands, UL subbands or flexible subbands.

FIG. 9 is a diagram showing Flexible TRS or CSI-RS in SBFD slots.

In another embodiment, NW indicates, and UE receives, Flexible TRS or CSI-RS in SBFD slots, refer to FIG. 9.

In this SBFD structure configuration, a number of slots/symbols wherein the frequency band is split into multiple subbands and wherein at least one subband is used for DL transmissions (subband D 91) and at least one subband is used for Flexible transmissions (subband F 92), then Flexible transmissions subband can further split to dedicate UL subband (subband U 93). Thus, the final flexible subbands will be around the UL subband. Further, a flexible TRS 94 or CSI-RS 95 is configured inside/outside/partly overlapping with the SBFD UL subband or flexible subband. UE will not receive TRS 94 or CSI-RS 95 when overlapping with UL scheduling (+ guard symbols, 2TA+DL-to-UL transient time). UE skips CSI feedback.

Otherwise, UE can receive TRS 94/CSI-RS 95 and send SRS/PUCCH/PUSCH . . . in same slots.

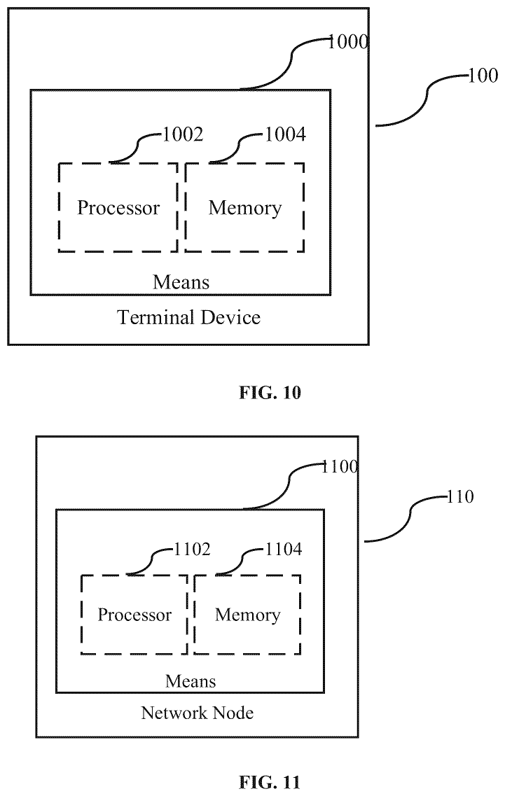

FIG. 10 is a block diagram showing an exemplary structure for the terminal device, according to exemplary embodiments of the present disclosure.

As shown in FIG. 10, the terminal device 100 comprises means 1000 configured for: receiving, from a network node, a subband full duplex, SBFD, slot configuration; and communicating, with the network node, based at least on the SBFD slot configuration. The slot configuration indicates a plurality of radio resources of a slot. The plurality of radio resources include: at least one downlink, DL, radio resource used for DL transmission; and at least one flexible radio resource used for flexible scheduling.

In exemplary embodiments of the present disclosure, the means 1000 are further configured for performing the method according any of the embodiments above mentioned, such as shown in FIG. 4A, 4B, 4C, 4D.

In exemplary embodiments of the present disclosure, the means 1000 comprise: at least one processor 1002; and at least one memory 1004 storing instructions that, when executed by the at least one processor 1002, cause the performance of the terminal device 100.

FIG. 11 is a block diagram showing an exemplary structure for the network node, according to exemplary embodiments of the present disclosure.

As shown in FIG. 11, a network node 110 comprises means 1100 configured for: transmitting, to a terminal device, a subband full duplex, SBFD, slot configuration; and communicating, with the terminal device, based at least on the SBFD slot configuration. The slot configuration indicates a plurality of radio resources of a slot. The plurality of radio resources include: at least one downlink, DL, radio resource used for DL transmission; and at least one flexible radio resource used for flexible scheduling.

In exemplary embodiments of the present disclosure, the means 1100 are further configured for performing the method according any of the embodiments above mentioned, such as shown in FIG. 5A, 5B.

In exemplary embodiments of the present disclosure, the means 1100 comprise: at least one processor 1102; and at least one memory 1104 storing instructions that, when executed by the at least one processor 1102, cause the performance of the network node 110.

The processor 1002, 1102 may be any kind of processing component, such as one or more microprocessor or microcontrollers, as well as other digital hardware, which may include digital signal processors (DSPs), special-purpose digital logic, and the like. The memory 1004, 1104 may be any kind of storage component, such as read-only memory (ROM), random-access memory, cache memory, flash memory devices, optical storage devices, etc.

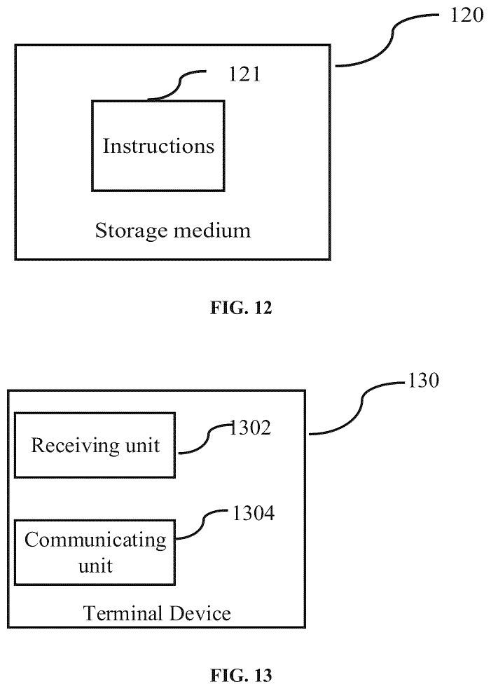

FIG. 12 is a block diagram showing an apparatus/computer readable storage medium, according to embodiments of the present disclosure.

As shown in FIG. 12, a computer-readable storage medium 120 storing instructions 121, which when executed by at least one processor of a terminal device, cause the at least one processor of the terminal device to perform the method according to any of the embodiments above mentioned, such as shown in FIG. 4A, 4B, 4C, 4D; or when executed by at least one processor of a network node, cause the at least one processor of the network node to perform the method according to any of the embodiments above mentioned, such as shown in FIG. 5A, 5B.

In addition, the present disclosure may also provide a carrier containing the computer program/instructions as mentioned above. The carrier is one of an electronic signal, optical signal, radio signal, or the above computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

FIG. 13 is a block diagram showing exemplary apparatus units for the terminal device, which is suitable for performing the method according to embodiments of the disclosure.

As shown in FIG. 13, the terminal device 130 may include: a receiving unit 1302, configured for receiving, from a network node, a subband full duplex, SBFD, slot configuration; and a communicating unit 1304, configured for communicating, with the network node, based at least on the SBFD slot configuration. The slot configuration indicates a plurality of radio resources of a slot. The plurality of radio resources include: at least one downlink, DL, radio resource used for DL transmission; and at least one flexible radio resource used for flexible scheduling.

In exemplary embodiments of the present disclosure, the terminal device 130 is further configured for performing the method according any of the embodiments above mentioned, such as shown in FIG. 4A, 4B, 4C, 4D.

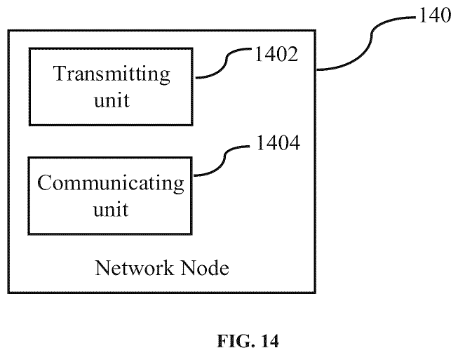

FIG. 14 is a block diagram showing exemplary apparatus units for the network node, which is suitable for performing the method according to embodiments of the disclosure.

As shown in FIG. 14, the network node 140 may include: a transmitting unit 1402, configured for transmitting, to a terminal device, a subband full duplex, SBFD, slot configuration; and a communicating unit 1404, configured for communicating, with the terminal device, based at least on the SBFD slot configuration. The slot configuration indicates a plurality of radio resources of a slot. The plurality of radio resources include: at least one downlink, DL, radio resource used for DL transmission; and at least one flexible radio resource used for flexible scheduling.

In exemplary embodiments of the present disclosure, the network node 140 is further configured for performing the method according any of the embodiments above mentioned, such as shown in FIG. 5A, 5B.

The term ‘unit’ may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

As used in the present disclosure, the term “circuitry” may refer to one or more or all of the following:
(a) hardware-only circuit implementations (such as implementations in only analogy and/or digital circuitry) and
(b) combinations of hardware circuits and software, such as (as applicable):
   (i) a combination of analogy and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in the present disclosure, including in any claims. As a further example, as used in the present disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

With these units, the apparatus may not need a fixed processor or memory, any kind of computing resource and storage resource may be arranged from at least one network node/device/entity/apparatus relating to the communication system. The virtualization technology and network computing technology (e.g., cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The term “non-transitory,” as used herein, is a limitation of the medium itself (i.e., tangible, not a signal) as opposed to a limitation on data storage persistency (e.g., RAM vs. ROM).

As described in above exemplary embodiments of this disclosure, embodiments herein afford many advantages. According to embodiments of the present disclosure, the exemplary embodiments of the present disclosure propose a mechanism to specifically configure/allocate resources for subband full duplex, SBFD, operation.

It should be understood that the above embodiments are only for illustration but not limitation. The present disclosure may be carried out in other ways than those specifically set forth herein without departing from essential characteristics of the disclosure. All changes to these embodiments not departing from the meaning and equivalency of the appended claims are intended to be comprised herein.

The followings are the references which are incorporated herein in their entirety:
[1] RP-213591, New SI: Study on evolution of NR duplex operation, 3GPP TSG RAN #94-e, Electronic Meeting, Dec. 6-17, 2021
[2] R1-2212115 Feasibility and techniques for Subband non-overlapping full duplex, 3GPP TSG RAN WG1, Meeting #111, Toulouse, France, Nov. 14-18, 2022
[3] 3GPP TS 38.331 V17.5.0 (2023-06)
[4] 3GPP TS 38.213 V17.6.0 (2023-06)

| ABBREVIATION | EXPLANATION |
|---|---|
| CORESET | Control resource set |
| SSB | System synchronization block |
| FDD | Frequency division duplexing |
| TDD | Time division duplexing |
| SIB | System Information Block |
| RAR | Random access response |
| TRS | Tracking Reference Signal |
| CRB | common resource block |
| BWP | Bandwidth part |
| RIV | Resource indicator value |
| SCS | sub carrier space |
| GB | Guardband |
| CSI-RS | channel state information reference signals |
| SLIV | Start and length indicator value |
| PUCCH | Physical uplink control channel |
| PRACH | Physical random-access channel |
| SRS | Sounding reference signal |
| PDCCH | Physical downlink control channel |
| TA | time advance |
| MAC CE | media access control control element |
| CLI | Cross link interference |
| CG | Configured grant |
| DCI | Downlink control information |
| DG | Dynamic grant |
| DL | Downlink |
| FDU | Full or flexible division duplexing |
| MCS | Modulation coding scheme |
| NW | Network |
| PUSCH | Physical uplink shared channel |
| PRB | Physical resource block |
| RF | Radio frequency |
| RRC | Radio resource control |
| SBFD | Subband non-overlapping full duplex |
| SLIV | Start and length indicator value |
| TBS | Transport block size |
| TDRA | Time domain resource assignment |
| UCI | Uplink control information |
| UE | User equipment |
| UL | Uplink |
| URLLC | Ultra-reliable low latency |
| xDD | Cross division duplexing |
| CSI | Channel Status Information |
| CSI-IM | Channel Status Information-Interference |
| | Measurement |
| ZP-CSIRS | Zero power-Channel Status Information |
| | reference signal |
| NZP-CSIRS | Non Zero power-Channel Status |
| | Information reference signal |
| CORESET | Control resource set |
| DMRS | demodulation reference signal |
| BW | bandwidth |
| CRB | common resource block |
| MIB | master information block |
| CCEs | control-channel elements |
| PCI | physical cell id |
| REGs | resource-element groups |

1. A method performed by a terminal device, comprising:
receiving, from a network node, a subband full duplex, SBFD, slot configuration; and
communicating, with the network node, based at least on the SBFD slot configuration;
wherein the slot configuration indicates a plurality of radio resources of a slot; and
wherein the plurality of radio resources include:
at least one downlink, DL, radio resource used for DL transmission; and
at least one flexible radio resource used for flexible scheduling.

2. A terminal device comprising:
at least one processor; and
at least one memory storing instructions that, when executed by the at least one processor, cause the terminal device to perform the following:
receiving, from a network node, a subband full duplex, SBFD, slot configuration; and
communicating, with the network node, based at least on the SBFD slot configuration;
wherein the slot configuration indicates a plurality of radio resources of a slot; and
wherein the plurality of radio resources include:
at least one downlink, DL, radio resource used for DL transmission; and
at least one flexible radio resource used for flexible scheduling.

3. The terminal device according to claim 2,
wherein the plurality of radio resources further include: at least one dedicated uplink, UL, radio resource used for UL transmission; and
wherein a dedicated UL radio resource in the at least one dedicated UL radio resource is surrounded by the at least one flexible radio resource, in a frequency domain and/or time domain.

4. The terminal device according to claim 3,
wherein the at least one dedicated UL radio resource is dedicated from a part of the at least one flexible radio resource, for UL transmission.

5. The terminal device according to claim 2,
wherein a frequency domain position of a radio resource in the plurality of radio resources is indicated by a start resource block, RB, and a number of RBs; and
wherein a time domain position of the radio resource is indicated by a slot, and a start symbol and a number of symbols in the slot.

6. The terminal device according to claim 5,
wherein at least one flexible control resource set, CORESET, is configured in the plurality of radio resources;
wherein a flexible CORESET of the at least one flexible CORESET is configured across at least one of: a DL radio resource, a flexible radio resource, and a dedicated UL radio resource; and
wherein the flexible CORESET is configured statically by radio resource control, RRC, or dynamically by downlink control information, DCI, or media access control control element, MAC CE.

7. The terminal device according to claim 6, further configured to perform:
monitoring a physical downlink control channel, PDCCH, in the flexible CORESET, when the flexible CORESET is earlier than an associated UL transmission by a predefined time length;
wherein the predefined time length is based on at least one of: a decoding time for the PDCCH, a time advance, TA, and a transient time from DL to UL of the terminal device.

8. The terminal device according to claim 7,
wherein when a UL transmission overlaps with the flexible CORESET, the UL transmission has a high priority than the PDCCH in the flexible CORESET.

9. The terminal device according to claim 8, further configured to perform:
judging (S408) whether all of the at least one flexible radio resource is dedicated for UL transmission, based on at least one of: the SBFD slot configuration or information from the flexible CORESET.

10. The terminal device according to claim 9,
wherein a flexible radio resource is used for guard band or DL transmission, when the flexible radio resource is not dedicated for UL transmission.

11. The terminal device according to claim 5,
wherein at least one reference signal from the network node is configured in the plurality of radio resources;
wherein a reference signal of the at least one reference signal is configured across at least one of: a DL radio resource, a flexible radio resource, and a dedicated UL radio resource.

12. The terminal device according to claim 11, further configured to perform:
receiving the reference signal, when the reference signal is earlier than an associated UL transmission by a predefined time length; and
transmitting based at least on a measurement result of the reference signal;
wherein the predefined time length is based on at least one of: a guard period, a time advance, TA, and a transient time from DL to UL of the terminal device.

13. The terminal device according to claim 12,
wherein the reference signal comprises at least one of: a tracking reference signal, TRS, or a flexible channel state information reference signal, CSI-RS.

14. The terminal device according to claim 2,
wherein the terminal device comprises a user equipment, UE; and
wherein the network node comprises a base station.

15. A method performed by a network node, comprising:
transmitting, to a terminal device, a subband full duplex, SBFD, slot configuration; and
communicating, with the terminal device, based at least on the SBFD slot configuration;
wherein the slot configuration indicates a plurality of radio resources of a slot; and
wherein the plurality of radio resources include:
at least one downlink, DL, radio resource used for DL transmission; and
at least one flexible radio resource used for flexible scheduling.

16. A network node comprising:
at least one processor; and
at least one memory storing instructions that, when executed by the at least one processor, cause the terminal device to perform the following:
transmitting, to a terminal device, a subband full duplex, SBFD, slot configuration; and
communicating, with the terminal device, based at least on the SBFD slot configuration;
wherein the slot configuration indicates a plurality of radio resources of a slot; and
wherein the plurality of radio resources include:
at least one downlink, DL, radio resource used for DL transmission; and
at least one flexible radio resource used for flexible scheduling.

17. The network node according to claim 16,
wherein a frequency domain position of a radio resource in the plurality of radio resources is indicated by a start resource block, RB, and a number of RBs; and
wherein a time domain position of the radio resource is indicated by a slot, and a start symbol and a number of symbols in the slot.

18. The network node according to claim 17,
wherein at least one flexible control resource set, CORESET, is configured in the plurality of radio resources;
wherein a flexible CORESET of the at least one flexible CORESET is configured across at least one of: a DL radio resource, a flexible radio resource, and a dedicated UL radio resource; and
wherein the flexible CORESET is configured statically by radio resource control, RRC, or dynamically by downlink control information, DCI, or media access control control element, MAC CE.

19. The network node according to claim 18,
wherein when the network node allocates radio resources for PDCCH in the flexible CORESET, the network node is configured to skip UL radio resources; and/or
wherein when a UL transmission overlaps with the flexible CORESET, the UL transmission has a high priority than the PDCCH in the flexible CORESET.

20. The method according to claim 17,
wherein at least one reference signal from the network node is configured in the plurality of radio resources;
wherein a reference signal of the at least one reference signal is configured across at least one of: a DL radio resource, a flexible radio resource, and a dedicated UL radio resource, and
wherein the network node is further configured to perform:
transmitting the reference signal earlier than an associated UL transmission by a predefined time length; and
receiving, from the terminal device, a transmission based at least on a measurement result of the reference signal;
wherein the predefined time length is based on at least one of: a guard period, a time advance, TA, and a transient time from DL to UL of the terminal device.
